(19) United States
(12) Patent Application Publication
(10) Pub. No.: US 2024/0392861 A1
(43) Pub. Date: Nov. 28, 2024

(54) CONNECTING CHAIN LINK FOR PURPOSES OF CONNECTING AT LEAST TWO CHAIN LINKS OF A CHAIN

(71) Applicant: pewag austria GmbH, Kapfenburg (AT)

(72) Inventors: Ägyd Pengg, Klagenfurt (AT); Franz Fuchs, Kapfenburg (AT); David Alexandru, Kapfenburg (AT)

(21) Appl. No.: 18/669,586

(22) Filed: May 21, 2024

(30) Foreign Application Priority Data
May 23, 2023 (EP) 23174815.3

(51) Int. Cl. F16G 15/12; F16G 15/04

(52) U.S. Cl. CPC F16G 15/12; F16G 15/04

(57) ABSTRACT

Connecting chain link (1) for purposes of connecting at least two chain links of a chain, wherein the connecting chain link (1) is configured and equipped so as to establish an articulated and detachable connection between two chain links, wherein the connecting chain link (1) has a main element (2) and a connecting element (3), wherein the main element (2) has a first nominal cross-section (D1) at least in some sections, wherein
the connecting element (3) can be inserted into an open section of the main element (2) along a direction of insertion (E), wherein a contact section (3a) of the connecting element (3) engages with a mating contact section (3a) of the main element (3), which is designed to correspond to the contact section (3a), wherein a connecting section (4) of the connecting chain link (1) has a second nominal cross-section (D2), which is essentially the same size as the first nominal cross-section (D1).

### TECHNICAL FIELD

The invention relates to a connecting chain link for purposes of connecting at least two chain links of a chain, in particular a linked chain or a round steel chain, whereby the connecting chain link is configured and equipped so as to produce an articulated and detachable connection between two chain links, wherein the connecting chain link has a main element and a connecting element, wherein in an open state of the connecting chain link, the main element and the connecting element are detached from one another, whereby two chain links that are to be connected can be connected to the main element, and in a closed state of the connecting chain link, the main element and the connecting element are detachably connected to one another, and form a closed shape, wherein the main element has a first nominal cross-section, at least in some sections.

### TECHNICAL BACKGROUND

In the prior art, chain links are usually connected with connecting links, whereby a connecting link connects two adjacent chain links. The connecting link usually has a C-shape with an open region, into which two chain links that are to be connected can be hooked. In order to produce a secure connection, the open region of the connecting link must be closed, wherein it is of known art to use threaded screws to close the open region. However, connecting links with threaded screws have the disadvantage of being expensive to manufacture. Furthermore, the diameter of the threaded screw must be significantly reduced compared to the diameter of the connecting link, in order to enable it to be screwed into the connecting link. This means that the threaded screw is usually the weakest link in the tensile strength of the connecting link, due to its reduced diameter.

The object of the present invention is to alleviate or eliminate the disadvantages of the prior art. The invention therefore aims in particular to create a connecting chain link in which the tensile strength is increased, and the production of which is simplified.

This object is achieved by a connecting chain link with the features of claim 1. Preferred embodiments are specified in the dependent claims.

### BRIEF DESCRIPTION OF THE INVENTION

In accordance with the invention, the connecting element can be inserted along a direction of insertion into an open section of the main element, so as to form the closed state, wherein in the closed state a contact section of the connecting element engages with a mating contact section of the main element, which is designed to correspond to the contact section, wherein that section of the connecting chain link in which the contact section engages with the mating contact section defines a connecting section of the connecting chain link, wherein in the closed state the connecting section has a second nominal cross-section, which is essentially the same size as the first nominal cross-section.

This results in the advantage that in the closed state the connecting chain link has a higher and constant nominal cross-section, in particular along its entire closed shape, (compared to a screw connection), and thus the tensile strength of the connecting chain link is increased, which in turn improves the reliability of connection between chain links that are connected to the connecting chain link. In this context, the nominal cross-section is to be understood as a synonym for the nominal diameter. In particular, the nominal cross-section, or nominal diameter, is defined as the thickness of a chain leg at a specific point along the chain leg. In a cross-section through a chain leg forming a chain link, the cross-section has a certain nominal cross-sectional area, which can have a certain geometry, e.g. circular or oval. For example, in the case of a circular nominal cross-sectional area, the nominal cross-section (or nominal diameter) is the diameter of the nominal circular cross-sectional area. In other words, the nominal cross-section can also be defined as the thickness of the leg of the chain link. The configuration of the engagement of the contact section with the correspondingly designed mating contact section can simplify the manufacture of the connecting chain link, compared to that of a screw connection. The connecting chain link is preferably manufactured from an investment casting, whereby its mechanical and metallurgical values can be similar or identical to those of the chain links that are to be connected. By virtue of the cross-sectional reinforcement (that is to say, the adaptation or harmonisation of the nominal cross-section at the contact section, and at the connecting element, to the nominal cross-section of the main element) of the connecting chain link, and the increased tensile strength that can thereby be achieved, system components can, for example, also be attached directly to the connecting chain link itself. This is particularly advantageous when using chains in poultry slaughtering systems.

It can be envisaged that the connecting element has a longitudinal extent, which, in the inserted state, is orientated parallel to a straight section of the main element, wherein the direction of insertion of the connecting element is preferably orientated orthogonally to its longitudinal extent, wherein the main element preferably has a longitudinal extent, wherein the direction of insertion of the connecting element is orientated orthogonally to the longitudinal extent of the main element.

It can be envisaged that the main element and the connecting element are designed such that the closed connecting chain link that can be formed from the latter has a constant nominal cross-section along its shape.

It can be envisaged that the contact section and the corresponding mating contact section form a latching or snap-in connection for purposes of fixing the connecting element in the inserted position, whereby the latching or snap-in connection can in particular be transferred from a fixing position to a releasing position, or from a releasing position to a fixing position, by a rotation of the connecting element about its longitudinal axis.

It can be envisaged that the main element has two end sections facing towards each other, between which the open section is designed, into which the connecting element can be inserted, wherein the mating contact section of the main element is designed on the end sections, wherein the contact section of the connecting element is designed on a side face of the connecting element, facing towards the main element, wherein in the closed state the contact section of the connecting element makes contact with the mating contact section of the main element, in particular over its entire surface.

It can be envisaged that in a main section plane of the connecting chain link, the mating contact section, along a direction that is orientated parallel to the longitudinal extent of the main element, has a profile that follows a rectangular pattern, a sawtooth pattern, or a triangular pattern.

It can be envisaged that in the main section plane the contact section of the connecting element has a profile, which is designed to correspond to the profile of the mating contact section of the main element, such that in the closed state the mating contact section makes contact with the contact section over its entire surface.

It can be envisaged that the connecting chain link further comprises a fixing element that is equipped so as to fix the connecting element in the closed state, whereby the fixing element preferably comprises a dowel pin.

It can be envisaged that the connecting element has a fixing opening into which the fixing element can be inserted, and that at least one end section of the main element has a contact surface, which is designed to correspond to the fixing element, wherein in the closed state the fixing element can be inserted into the fixing opening, wherein in the inserted state the fixing element makes contact with the contact surface in such a way that any movement of the connecting element against the direction of insertion is blocked.

It can be envisaged that the main element comprises two opposing chain link curves, which are connected to each other via an essentially straight chain link leg, wherein the straight chain link leg has the first nominal cross-section.

It can be envisaged that in the closed state, the connecting element is located opposite the straight chain link leg.

It can be envisaged that the main element is essentially C-shaped, whereby the connecting element can be inserted into the open section of the C-shaped main element.

It can be envisaged that in the closed state, the connecting element is connected to the main element such that the connecting chain link thereby formed is configured to be essentially round, in particular to be circular or oval.

It can be envisaged that the engagement of the contact section with the corresponding mating contact section secures the connecting element against rotation about its longitudinal axis, which is orientated orthogonally to the direction of insertion.

It can be envisaged that the connecting element has two end regions on which the contact section is formed, wherein the connecting element has a third nominal cross-section between the end regions, which is essentially the same size as the first nominal cross-section.

### BRIEF DESCRIPTION OF THE FIGURES

The invention is explained further below with reference to a preferred example of embodiment, to which, however, it is not intended to be limited. In the figures:

FIG. 1 shows a perspective view of an inventive connecting chain link in the open state;

FIG. 2 shows the connecting chain link in accordance with FIG. 1 in the closed state;

FIG. 3 shows a cross-sectional view of the connecting chain link in accordance with FIG. 1;

FIG. 4a shows a second form of embodiment of a connecting chain link;

FIG. 4b shows another view of the connecting chain link in accordance with FIG. 4a;

FIG. 4c shows another view of the connecting chain link in accordance with FIG. 4a;

FIGS. 5a-5d show cross-sections through a connecting section of an inventive connecting chain link in various states; and

FIG. 6 shows a detail of a cross-section of another form of embodiment of a connecting chain link.

### DETAILED DESCRIPTION OF THE FORMS OF EMBODIMENT

FIG. 1 shows a perspective view of an inventive connecting chain link 1 for purposes of connecting at least two chain links of a chain (not shown). The chain can be, for example, a linked chain, or a round steel chain. The connecting chain link 1 is configured and equipped so as to produce an articulated and detachable connection between two chain links. The connecting chain link 1 comprises a main element 2 and a connecting element 3, whereby in an open state of the connecting chain link 1, which is shown in FIG. 1, the main element 2 and the connecting element 3 are detached from each other. As a result, two chain links that are to be connected can be connected to the main element 2, that is to say, hooked into the main element 2. The main element 2 is essentially C-shaped, whereby the connecting element 3 can be inserted into the open section of the C-shaped main element 2. The main element 2 can have any open shape (e.g. U-shaped, V-shaped, semi-circular, etc.), whereby an open section of the open shape can be closed with the connecting element 3.

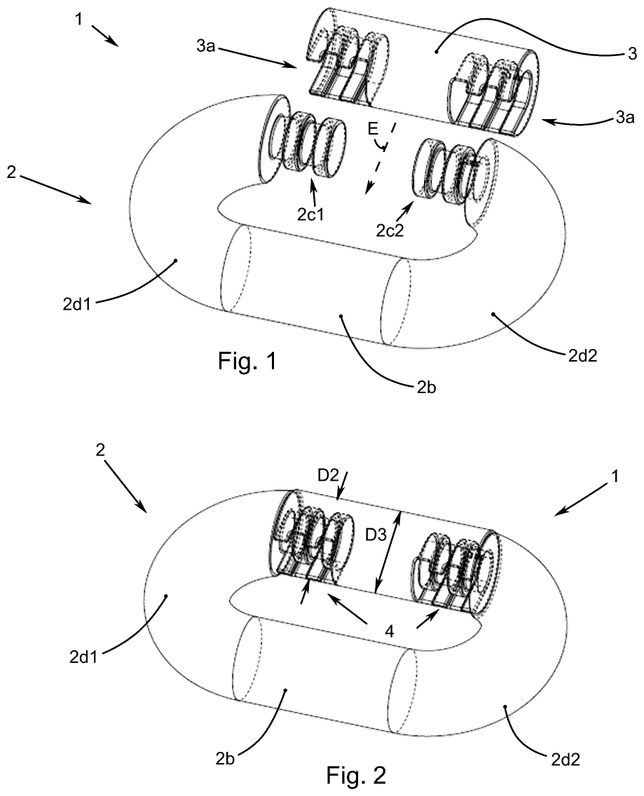

FIG. 2 shows a closed state of the connecting chain link 1. The main element 2 and the connecting element 3 are (detachably) connected to each other, and thus form a closed shape. The main element 2 has a first nominal cross-section D1, at least in some sections.

In order to form the closed state, the connecting element 3 can be inserted into the open section of the main element 2 along a direction of insertion E. In the closed state, a contact section 3a of the connecting element 3 engages with a mating contact section 2a of the main element 2, which is designed to correspond to the contact section 3a. That section of the connecting chain link 1 in which the contact section 3a engages with the mating contact section 2a defines a connecting section 4 of the connecting chain link 1. In the closed state, the connecting section 4 has a second nominal cross-section D2, which is essentially the same size as the first nominal cross-section D1.

The main element 2 comprises two end sections 2c1, 2c2 that face towards each other, between which the open section is formed, into which the connecting element 3 can be inserted. The mating contact section 2a of the main element 2 is formed on the end sections 2c1, 2c2. The contact section 3a of the connecting element 3 is formed on a side face of the connecting element 3 facing towards the main element 2. In the closed state, the contact section 3a of the connecting element 3 makes contact with the mating contact section 2a of the main element 2, preferably over its entire surface.

In the example of embodiment shown, the main element 2 has two opposing chain link curves 2d1, 2d2, which are connected to each other by way of a straight section 2b of the main element 2. In the example shown, the straight section 2b is a straight chain link leg. Furthermore, the straight section 2b has the first nominal cross-section D1.

The main element 2 and the connecting element 3 are designed such that the closed connecting chain link 1 that can be formed from them has a constant nominal cross-section along its shape.

The connecting element 3 has a longitudinal extent L2, which in the inserted state is orientated parallel to the straight section 2b of the main element 2. The direction of insertion E of the connecting element 3 is orientated orthogonally to its longitudinal extent L2. The main element 2 preferably has a longitudinal extent L1, whereby the direction of insertion E of the connecting element 3 is also orientated orthogonally to the longitudinal extent L1 of the main element 2.

The connecting element 3 further comprises two end regions on which the contact section 3a is formed, whereby between the end regions the connecting element 3 has a third nominal cross-section D3, which is essentially the same size as the first nominal cross-section D1.

In the closed state, the connecting element 3 is located opposite the straight section 2b. Furthermore, in the closed state, the connecting element 3 is connected to the main element 2 such that the connecting chain link 1 formed from the latter is essentially configured to be round, in particular to be circular or oval. In the assembled state, the main element 2 and the connecting element 3 can essentially have the shape of a chain link.

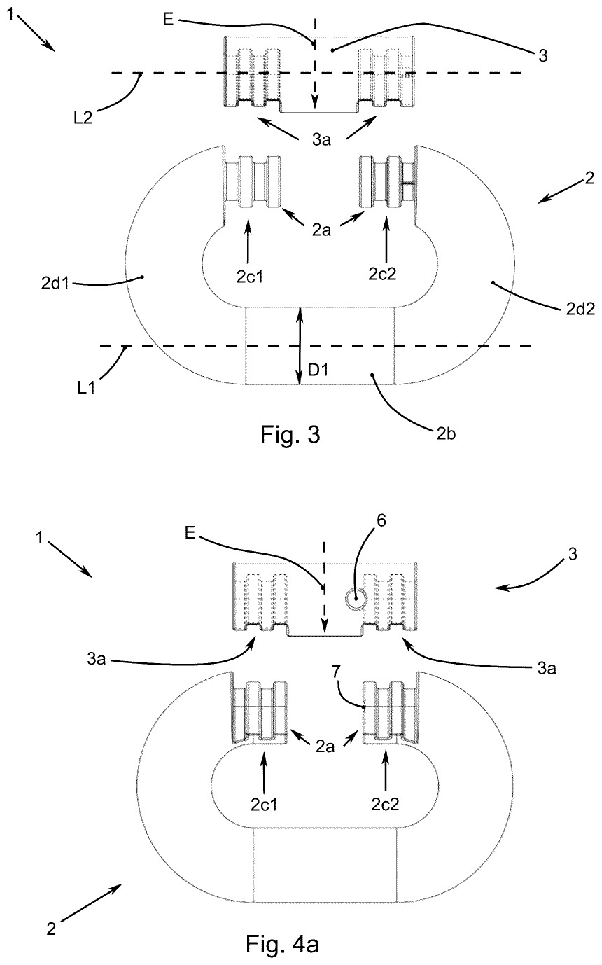

As shown in FIG. 3, in a main section plane of the connecting chain link 1, the mating contact section 2a follows a profile along a direction that is orientated parallel to the longitudinal extent L1 of the main element 2. The profile can be described as a rectangular pattern, a sawtooth pattern, or a triangular pattern.

In the main section plane, the contact section 3a of the connecting element 3 also follows a profile that is designed to correspond to the profile of the mating contact section 2a of the main element 2, so that in the closed state the mating contact section 2a makes contact with the contact section 3a over its entire surface.

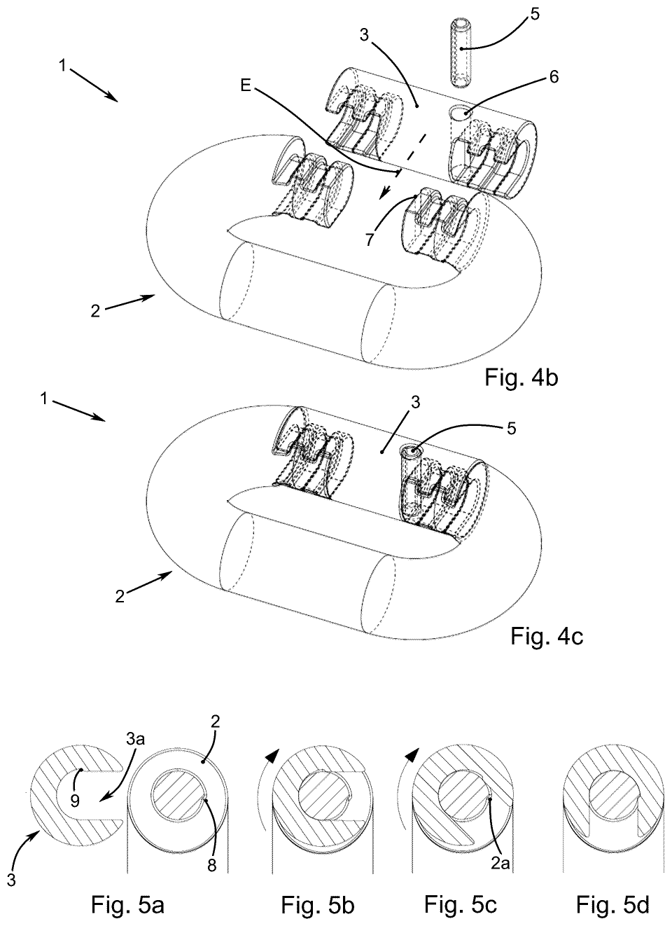

FIGS. 4a to 4c show views of a second form of embodiment of an inventive connecting chain link 1, comprising a fixing element 5, which is equipped so as to fix the connecting element 3 in the closed state, wherein the fixing element 5 is preferably a dowel pin.

The connecting element 3 has a fixing opening 6 for this purpose, into which the fixing element 5 can be inserted. At least one end section 2c2 of the main element 2 has a contact surface 7, which is designed to correspond to the fixing element 5. In the closed state, the fixing element 5 can be inserted into the fixing opening 6. In the inserted state, the fixing element 5 makes contact with the contact surface 7 such that any movement of the connecting element 3 against the direction of insertion E is blocked.

FIG. 4a shows a side view of the open state. FIG. 4b shows a perspective view of the open state, with a fixing element 5 that is not inserted. FIG. 4c shows the closed state, with the fixing element 5 inserted into the fixing opening 6.

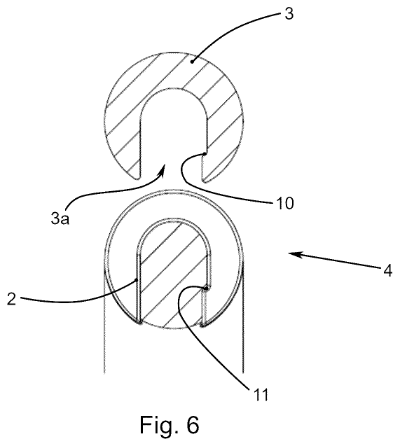

Another method of fixing the connecting element 3 to the main element 2 is shown in FIGS. 5a to 5d and FIG. 6. The connecting element 3 can be secured against rotation about its longitudinal axis by a latching or snap-in engagement of the contact section 3a with the corresponding mating contact section 2a.

As shown in FIGS. 5a to 5d, the contact section 3a and the corresponding mating contact section 2a form a latching or snap-in connection for purposes of fixing the connecting element 3 in the inserted position. By a rotation of the connecting element around its longitudinal axis, the latching or snap-in connection can be moved from a fixing position to a releasing position, or from a releasing position to a fixing position. In the fixing position, a latching lug 8 on the mating contact section 2a engages in a latching recess 9 on the contact section 3a. FIGS. 5a to 5d in each case show a cross-section through the connecting section 4. FIG. 5a shows the open state. In FIG. 5b, the connecting element 3 is inserted into the main element 2. In FIG. 5c, the connecting element 3 is rotated through a first angle relative to the main element 2 (the direction of rotation is indicated by an arrow). In FIG. 5d, the connecting element 3 is rotated relative to the main element 2 through a second, larger angle, as a result of which the latching or snap-in connection is engaged and the connecting element 3 is fixed to the main element 2.

To release the latching or snap-in connection, the connecting element can be rotated in the opposite direction, whereby here an unlocking force must be overcome in order to unlock the latching or snap-in connection.

FIG. 6 shows an alternative variant of the latching or snap-in connection between the contact section 3a and the mating contact section 2a. The cross-section through the connecting section 4 shown in FIG. 6 shows the open state. The connecting element 3, which is essentially C-shaped in cross-section, can be inserted on the mating contact section 2a of the main element 2, whereby a projection 10 formed on the contact section 3a can snap into an indentation 11 formed on the mating contact section 2a so as to fix the connecting element 3 in place. Compared to the fixing shown in FIGS. 5a to 5d, this fixing does not involve any rotation.

1. Connecting chain link (1) for purposes of connecting at least two chain links of a chain, in particular a linked chain or a round steel chain, wherein
the connecting chain link (1) is configured and equipped so as to produce an articulated and detachable connection between two chain links, wherein
the connecting chain link (1) has a main element (2) and a connecting element (3), wherein
in an open state of the connecting chain link (1), the main element (2) and the connecting element (3) are detached from each other, whereby
two chain links to be connected can be connected to the main element (2), and in a closed state of the connecting chain link (1) the main element (2) and the connecting element (3) are detachably connected to each other, and form a closed shape, wherein
the main element (2) has a first nominal cross-section (D1) at least in some sections,
characterised in that,
the connecting element (3) can be inserted into an open section of the main element (2) along a direction of insertion (E), so as to form the closed state, wherein
in the closed state, a contact section (3a) of the connecting element (3) engages with a mating contact section (2a) of the main element (2), which is designed to correspond to the contact section (3a), wherein
that section of the connecting chain link (1) at which the contact section (3a) engages with the mating contact section (2a) defines a connecting section (4) of the connecting chain link (1), wherein
in the closed state, the connecting section (4) has a second nominal cross-section (D2), which is essentially the same size as the first nominal cross-section (D1).

2. Connecting chain link in accordance with claim 1, wherein
the connecting element (3) has a longitudinal extent (L2) which, in the inserted state, is orientated parallel to a straight section (2b) of the main element (2), wherein
the direction of insertion (E) of the connecting element (3) is preferably orientated orthogonally to its longitudinal extent (L2), wherein
the main element (2) preferably has a longitudinal extent (L1), wherein
the direction of insertion (E) of the connecting element (3) is orientated orthogonally to the longitudinal extent (L1) of the main element (2).

3. Connecting chain link in accordance with one of the preceding claims, wherein
the main element (2) and the connecting element (3) are designed such that the closed connecting chain link (1) that can be formed from them has a constant nominal cross-section along its shape.

4. Connecting chain link in accordance with one of the preceding claims, wherein
the contact section (3a) and the corresponding mating contact section (2a) form a latching or snap-in connection, for purposes of fixing the connecting element (3) in the inserted position, wherein
in particular by a rotation of the connecting element about its longitudinal axis, the latching or snap-in connection can be transferred from a fixing position to a releasing position, or from a releasing position to a fixing position.

5. Connecting chain link in accordance with one of the preceding claims, wherein
the main element (2) has two end sections (2c1, 2c2) facing towards each other, between which the open section is formed, into which the connecting element (3) can be inserted, wherein
the mating contact section (2a) of the main element (2) is formed on the end sections (2c1, 2c2), wherein
the contact section (3a) of the connecting element (3) is formed on a side face of the connecting element (3) facing towards the main element (2), wherein
in the closed state, the contact section (3a) of the connecting element (3) makes contact with the mating contact section (2a) of the main element (2), in particular over its entire surface.

6. Connecting chain link in accordance with claim 5, wherein
in a main section plane of the connecting chain link (1), the mating contact section (2a) has a profile along a direction which is orientated parallel to the longitudinal extent (L1) of the main element (2), which profile follows a rectangular pattern, a sawtooth pattern, or a triangular pattern.

7. Connecting chain link in accordance with claim 6, wherein
in the main section plane, the contact section (3a) of the connecting element (3) has a profile that is designed to correspond to the profile of the mating contact section (2a) of the main element (2), so that in the closed state the mating contact section (2a) makes contact with the contact section (3a) over its entire surface.

8. Connecting chain link in accordance with one of the preceding claims,
comprising a fixing element (5) which is equipped so as to fix the connecting element (3) in the closed state, wherein
the fixing element (5) preferably comprises a dowel pin.

9. Connecting chain link in accordance with claim 8, wherein
the connecting element (3) has a fixing opening (6), into which the fixing element (5) can be inserted, and at least one end section (2c1, 2c2) of the main element (2) has a contact surface (7), which is designed to correspond to the fixing element (5), wherein
in the closed state, the fixing element (5) can be inserted into the fixing opening (6), wherein
in the inserted state, the fixing element (5) contacts the contact surface (7) such that any movement of the connecting element (3) against the direction of insertion (E) is blocked.

10. Connecting chain link in accordance with one of the preceding claims, wherein
the main element (2) comprises two opposing chain link curves (2d1, 2d2), which are connected to one another via the straight section (2b) of the main element (2), which in particular is a straight chain link leg, wherein
the straight section (2b) has the first nominal cross-section (D1).

11. Connecting chain link in accordance with claim 10, wherein
in the closed state, the connecting element (3) is located opposite the straight section (2b).

12. Connecting chain link in accordance with one of the preceding claims, wherein
the main element (2) is essentially C-shaped, wherein
the connecting element (3) can be inserted into the open section of the C-shaped main element (2).

13. Connecting chain link in accordance with one of the preceding claims, wherein
in the closed state, the connecting element (3) is connected to the main element (2) such that the connecting chain link (1) formed from it is essentially round, in particular is circular or oval.

14. Connecting chain link in accordance with one of the preceding claims, wherein
the connecting element (3) is secured against rotation about its longitudinal axis, which is orientated orthogonally to the direction of insertion (E), by the engagement of the contact section (3a) with the corresponding mating contact section (2a).

15. Connecting chain link in accordance with one of the preceding claims, wherein
the connecting element (3) has two end regions at which the contact section (3a) is formed, wherein
between the end regions, the connecting element (3) has a third nominal cross-section (D3), which is essentially the same size as the first nominal cross-section (D1).
